(19) United States
(12) Patent Application Publication
(10) Pub. No.: US 2024/0105352 A1
(43) Pub. Date: Mar. 28, 2024

(54) CEMENTITIOUS SHIELDING COMPOSITION FOR THE WIDE-SPECTRUM CAPTURE OF THERMAL, EPITHERMAL, AND FAST NEUTRONS

(71) Applicants: University of Florida Research Foundation, Inc., Gainesville, FL (US); RJ Lee Group, Inc., Monroeville, PA (US); Concrete Engineering Consultants, Inc., Charlotte, NC (US)

(72) Inventors: Jerry M. PARIS, Gainesville, FL (US); Christopher C. FERRARO, Gainesville, FL (US); Kyle A. RIDING, Gainesville, FL (US); Ashish D. PATEL, Gainesville, FL (US); James E. BACIAK, Gainesville, FL (US); Eric R. GIANNINI, Gainesville, FL (US); W. Calvin MCCALL, Gainesville, FL (US)

(21) Appl. No.: 18/275,147

(22) PCT Filed: Feb. 1, 2022
(86) PCT No.: PCT/US2022/070449

§ 371 Date: Jul. 31, 2023

Related U.S. Application Data
(60) Provisional application No. 63/144,225, filed on Feb. 1, 2021.

(51) Int. Cl. G21F 1/04; G21C 11/02

(52) U.S. Cl. CPC G21F 1/042; G21C 11/028

(57) ABSTRACT

The present disclosure provides for cementitious shielding compositions, methods of making the cementitious shielding composition, structures incorporating the concrete cementitious shielding composition, and the like, where the cementitious shielding composition includes elemental boron and/or a boron compound, for example as boron particles. The boron particles can be homogeneously distributed throughout the cementitious shielding composition and can have a largest least dimension of about 100 microns or less. The present disclosure, in some aspects, can reduce or eliminate problems associated with minerals found in concrete aggregates, because those materials are degraded over time by neutron radiation, which leads to disorganized lattice structures, manifested as damage by radiation-induced volumetric expansion (RIVE), and potentially further damage from alkali-silica reaction (ASR).

### CROSS-REFERENCE TO RELATED APPLICATIONS

This application claims priority to, co-pending U.S. Patent Application entitled “CEMENTITIOUS SHIELDING COMPOSITION FOR THE WIDE-SPECTRUM CAPTURE OF THERMAL, EPITHERMAL, AND FAST NEUTRONS,” filed on Feb. 1, 2021, and assigned application Ser. No. 63/144,225, each of which are incorporated herein by reference in their entireties.

### STATEMENT REGARDING FEDERALLY SPONSORED RESEARCH OR DEVELOPMENT

This invention was made with government support under Grant No. DE-AR0001142 awarded by the Department of Energy. The government has certain rights in the invention.

### BACKGROUND

Nuclear power generation facilities are seeking operational license extensions to 80 and 100 years of service life; well beyond the initial 40-year anticipated operational service life. Existing traditional concrete shielding for structural components that experience neutron radiation utilize boron aggregates primarily composed of sizes greater than ¼ in. (6 mm) in nominal diameter as a neutron absorber. This application shields the outer containment structure, and personnel/equipment within, from neutron radiation, but leaves the biological shielding concrete elements exposed to neutron damage due to the heterogeneous dispersion of the aggregates throughout the concrete structure. Crystalline materials are degraded over time by neutron radiation leading to disorganized lattice structures making the aggregates more susceptible to radiation-induced volumetric expansion (RIVE) and alkali-silica reaction (ASR).

### SUMMARY

Embodiments of the present disclosure provide for cementitious shielding compositions, methods of making the cementitious shielding composition, structures incorporating the concrete cementitious shielding composition, and the like, where the cementitious shielding composition includes elemental boron and/or a boron compound, for example as boron particles.

In an embodiment, the present disclosure provides for a cementitious shielding composition comprising: a fine aggregate, hydrogenous compounds, hydraulic compounds, optionally an additive, and optionally boron particles; wherein the boron particles are present in the fine aggregate, the hydrogenous compounds, the hydraulic compounds, or a combination thereof or wherein the boron particles are present separately from the fine aggregate, the hydrogenous compounds, the hydraulic compounds, or present in the fine aggregate, the hydrogenous compounds, the hydraulic compounds, or a combination thereof and wherein the boron particles present separately from the fine aggregate, the hydrogenous compounds, the hydraulic compounds; wherein the boron particles comprise a boron compound, elemental boron, or a combination thereof, wherein the boron particles have a largest least dimension of about 100 microns or less, wherein the boron particles are dispersed homogeneously in the cementitious shielding composition.

In another aspect, the present disclosure provides for cementitious shielding composition comprising: a fine aggregate, hydrogenous compounds, hydraulic compounds, optionally an additive, and optionally boron particles; wherein the fine aggregates include fine aggregate particles, wherein the hydrogenous compounds are in the form of hydrogenous particles, wherein the hydraulic compounds are in the form of hydraulic particles; wherein one or more of the fine aggregate particles, hydrogenous particles, hydraulic particles, or a combination thereof have a boron coating, wherein the boron coating comprises boron particles, wherein the boron particles comprise a boron compound, elemental boron, or a combination thereof, wherein the boron particles have a largest least dimension of about 100 microns or less, wherein the boron particles is dispersed homogeneously in the cementitious shielding composition.

The present disclosure also provides for a structure comprising a coating made from the cementitious shielding composition such as those described or herein. In a particular embodiment, the coating has a thickness of about 1 mm to 150 mm. In a particular embodiment, the coating has a thickness of about ¼ inches (6 mm), to 6 inches (150 mm).

Other devices, methods, features, and advantages will be or become apparent to one with skill in the art upon examination of the following drawings and detailed description. It is intended that all such additional devices, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a schematic of a testing configuration that includes a Pu-Be source that is placed into a high-density polyethylene transport drum with a collimation port. A cadmium sheet with a hole the diameter of the collimation port was placed over the transport drum to shield against neutrons interacting with the detector that bypass the specimens. Specimens of differing compositions were placed above the collimation port to expose the specimens directly to the Pu-Be source and a ³He detector was placed behind the specimens to measure neutrons passing through the specimens as shown below.

FIG. 2 illustrates a graph of data collected using the testing configuration illustrated in FIG. 1. Three compositions were evaluated: typical nuclear shielding concrete containing heavyweight aggregate utilizing a mixture design and aggregate source from a proton therapy facility, a portland cement mortar composition with 4 kg ¹⁰B/m³ using boron carbide as a sand replacement, and a portland cement mortar composition with 20 kg ¹⁰B/m³ using boron carbide as a sand replacement along with 20% HDPE as a sand replacement. Each mixture was used to create specimens having thicknesses of 1, 3, and 5 cm. Utilizing stacked specimens, shielding at thicknesses of 1, 3, 4, 5, 6, 8, and 9 cm was performed.

FIG. 3 illustrates a graph of additional data collected using the testing configuration illustrated in FIG. 1. In this configuration a cadmium sheet was placed over the collimation port to shield against thermal neutrons prior to exposing the specimens (meaning the specimens were being exposed to a nearly pure fast-neutron source. As with the data collected in FIG. 2, three compositions were evaluated: typical nuclear shielding concrete containing heavyweight aggregate utilizing a mixture design and aggregate source from a proton therapy facility, a portland cement mortar composition with 4 kg ¹⁰B/m³ using boron carbide as a sand replacement, and a portland cement mortar composition with 20 kg ¹⁰B/m³ using boron carbide as a sand replacement along with 20% HDPE as a sand replacement. Each mixture was used to create specimens having thicknesses of 1, 3, and 5 cm. Utilizing stacked specimens, shielding at thicknesses of 1, 3, 4, 5, 6, 8, and 9 cm was performed.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, is to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of chemistry, materials science, nuclear chemistry and physics, and the like, which are within the skill of the art. Such techniques are explained fully in the literature.

Prior to describing the various embodiments, the following definitions are provided and should be used unless otherwise indicated.

Unless otherwise defined, all technical and scientific terms used herein have the same meaning as commonly understood by one of ordinary skill in the art of inorganic chemistry, materials science, and/or nanotechnology. Although methods and materials similar or equivalent to those described herein can be used in the practice or testing of the present disclosure, suitable methods and materials are described herein.

Discussion:

Embodiments of the present disclosure provide for cementitious shielding compositions, methods of making the cementitious shielding composition, structures incorporating the concrete cementitious shielding composition, and the like, where the cementitious shielding composition includes elemental boron and/or a boron compound, for example as boron particles. The boron particles (e.g., including the boron and/or a boron compound) are homogeneously distributed throughout the cementitious shielding composition (unlike how naturally present B might be distributed) and can have a largest least dimension of about 100 microns or less (e.g., about 1 micron to 100 microns). Embodiments of the present disclosure can reduce (e.g., by about 50%, about 60%, about 70%, about 80%, about 90% or more) or eliminate problems associated with minerals found in concrete aggregates, because those materials are degraded over time by neutron radiation, which leads to disorganized lattice structures, manifested as damage by radiation-induced volumetric expansion (RIVE), and potentially further damage from alkali-silica reaction (ASR).

In an aspect, the cementitious shielding composition can be applied to the surface of a radiation-exposed concrete structure as a coating to provide exceptional shielding of fast, epi-thermal, and thermal neutrons in a thin cross-section (e.g., about 0.25 inches (6 mm) up to 8 inches (200 mm)), which should extend the useful life of what is being shielded. For example, the cementitious shielding composition can be applied to structures such as nuclear reactor biological shields, nuclear reactor buildings, nuclear storage, nuclear containment, piping, and the like, that are present in nuclear power plants, neutron therapy facilities, proton therapy facilities, and the like.

In another aspect, the cementitious shielding composition can be part (e.g., a coating or layer) of a pre-formed structure (e.g., panel) that can be placed in proximity to structures, devices, and/or personnel, in need of such shielding from fast, epi-thermal, and thermal neutrons, which should extend the lifetime of what is protected. This approach allows for quick assembly or disassembly and positioning in places where coating a structure is not optimal or optional or when additional shielding is desired. As with the embodiment described above, the panels including the cementitious shielding composition can be used in nuclear reactor biological shields, nuclear reactor buildings, nuclear storage, nuclear containment, adjacent piping, and the like, that are present in nuclear power plants, neutron therapy facilities, proton therapy facilities, and the like.

Aspects of the present disclosure provide for utilizing boron particles (e.g., elemental boron and/or a boron compound) that are included in the cementitious shielding composition. In an embodiment, the cementitious shielding composition includes a fine aggregate, hydrogenous compounds, hydraulic compounds, optionally an additive, and optionally boron particles. The boron particles can be present in the fine aggregate, the hydrogenous compounds, the hydraulic compounds, or a combination thereof. In addition, or alternatively, the boron particles can be present separately from the fine aggregate, the hydrogenous compounds, and/or the hydraulic compounds, but are present as separate boron particles in the cementitious shielding composition. In addition, or alternatively, the boron particles can be present in the fine aggregate, the hydrogenous compounds, the hydraulic compounds, or a combination thereof and are also present separately from the fine aggregate, the hydrogenous compounds, and/or the hydraulic compounds in the form of boron particles.

In each of the embodiments described above and herein, where the cementitious shielding composition is used it can have a thickness of about ¼ inches (6 mm), to 8 inches (200 mm), about 6 mm to 150 mm, about 1 mm to 200 mm, about 1 mm to 150 mm, about 1 mm to 10 mm, about 3 mm to 10 mm, or about 3 mm to 9 mm.

In another embodiment, the cementitious shielding composition includes the components described above, where the fine aggregates can include fine aggregate particles, the hydrogenous compounds are in the form of hydrogenous particles, and the hydraulic compounds are in the form of hydraulic particles. One or more of the fine aggregate particles, hydrogenous particles, hydraulic particles, or a combination thereof have a boron coating, where the coating can have a thickness of about ¼ inches (6 mm), to 8 inches (200 mm), about 6 mm to 150 mm, about 1 mm to 200 mm, about 1 mm to 150 mm, about 1 mm to 10 mm, about 3 mm to 10 mm, or about 3 mm to 9 mm. The boron coating includes boron particles.

The cementitious shielding has the characteristic that when shielding a concrete structure, the cementitious shielding composition reduces neutron flux from reaching beyond the coating leading radiation-induced volumetric expansion of the one or more types of the aggregate particles in the concrete relative to concrete that does not include the cementitious shielding composition. The cementitious shielding composition has an elemental boron composition (e.g., from one or a combination of elemental boron (e.g., natural occurring abundance or isotopically altered) and/or boron compound) of about 1 to 10 weight percent of the cementitious shielding composition, where the isotopes of boron can occur in the naturally occurring abundance or in an isotopically altered abundance. In an aspect, the elemental boron composition of the cementitious shielding composition can be made so that the abundance of ¹⁰B is greater than the naturally occurring abundance of ¹⁰B.

The boron particles can include a boron compound, elemental boron, or a combination thereof The boron particles can have a largest least dimension of about 100 microns or less (e.g. about 1 micron to 100 microns, about 0.1 microns to 100 microns, about 1 micron to 75 microns, about 0.1 microns to 75 microns, about 1 micron to 50 microns, or about 0.1 microns to 50 microns). The boron particles are dispersed homogeneously in the cementitious shielding composition.

The boron compounds can include: boron minerals, organoboron compounds, borates and their hydrated forms, borate esters and their hydrated forms, borate salts and their hydrated forms, ionic borohydrides, and a combination thereof. The boron minerals can include, for example, colemanite, ulexite, kernite, boracite, painite, tincal, and the like. The organoboron compounds can include boronic acid, orthcarboranes, metacarboranes, paracarboranes, boron carbide, and the like. The borates, borate esters, borate salts, and their hydrated forms can include boric acid, borosilicates, sodium metaborates, lithium metaborates, sodium borates, calcium borates, calcium metaborates, sodium pentaborates, zinc borates, and the like. The ionic borohydrides can include potassium-, lithium-, cesium-, or sodium-dodecahydrododecaborates and the like.

The fine aggregates are about 10 to 80 weight percent of the cementitious shielding composition. The fine aggregates can include natural or synthetic sand, crushed stone, or gravel, where the particles can pass through a 3/8-inch (9.5 mm) sieve. In an aspect, in addition to or replacing a portion of the fine aggregates described herein, a portion of the fine aggregate can high density polyethylene having dimensions can pass through a 3/8-inch (9.5 mm) sieve. The portion of the fine aggregates that can be high density polyethylene can be about 1 to 25 weight percent of the fine aggregate.

The additive, when present, can be about 0.1 to 10 weight percent of the cementitious shielding composition. The additive can includes liquid or solid plasticizing admixtures, water reducing admixtures, air-entraining admixtures, viscosity modifying admixtures, set retarding admixtures, set accelerating admixtures, internal curing admixtures, alkali activators, biofilm bacterium, activated carbon, carbon powder (carbon black), synthetic fibers, glass fibers, carbon fibers, basalt fibers, steel fibers, aluminum fibers, cellulose fibers, plant-based fibers, or combinations thereof.

The hydraulic binder, when present, can be about 10 to 40 weight percent of the cementitious shielding composition. The hydraulic binder can be in the form of particles that have a largest least dimension of about 100 microns or less, (e.g., about 0.1 to 100 microns, about 0.1 to 50 micron, about 10 to 50 microns, about 0.1 to 10 microns, about 10 to 100 microns). The hydrogenous compounds can be dispersed homogeneously in the cementitious shielding composition. The binder includes portland cement, blended cement, slag cement, fly ash, natural pozzolans, silica fume, metakaolin, geopolymer, alkali-activated slag cement, calcium sulfoaluminate cement, calcium aluminate cement, belite cement, lime cement, supplementary cementitious materials not meeting ASTM C618, or combinations thereof.

The hydrogenous compounds are about 1 to 65 weight percent of the cementitious shielding composition. The hydrogenous compounds can be in the form of particles that have a largest least dimension of about 100 microns or less (e.g., about 0.1 to 100 microns). The hydrogenous compounds can be dispersed homogeneously in the cementitious shielding composition. The hydrogenous compounds include hydrated cement phases, cementitious pore fluid, hydrated minerals/salts (e.g., micas, clays, serpentines, chlorites, tectosilicate zeolites, hydroxide and/or hydrous sulfates, etc.), inorganic polymers (e.g., polyborates, silanes, polysilanes, siloxanes, polysiloxanes, polysilynes, alkali silicates, etc.), organic polymers (e.g., latex, nylon, polyethylene, polypropylene, ethylene glycol, propylene glycol, polystyrene, polyvinyl alcohol, phenolic resins, etc.), or combinations thereof.

In addition to the components described herein, the cementitious shielding composition can further comprise high density polyethylene. The high-density polyethylene can be about 1 to 20 weight percent of the cementitious shielding composition.

The following is provided to describe the cement, cement phases (e.g., hydrated cement phases), and concrete and how the cementitious shielding composition can be formed. The cementitious shielding composition can be applied to the surface of a concrete structure, wall, column, or the like.

In general, the most common type of cement is portland cement, but other types of cement (e.g., calcium sulfoaluminate cement and calcium aluminate cements) can be used herein as well. In general, portland cement is a mixture of silica, calcium oxide, with small amounts of alumina and iron oxide. During the preparation of the cement, limestone (calcium carbonate) and silica are heated so hot that they form a melted glassy phase of calcium silicates (mainly dicalcium silicate, and tricalcium silicate), and the alumina and iron are used to lower the melting point and they form calcium aluminate and tetracalcium aluminoferrite (these are minor phases) which take part in other side reactions. Once this glassy mixture melts and cools, it forms clinkers (little balls) where are ground to a powder along with some gypsum (calcium sulfate) to form cement.

In addition, other materials can be added to the cement during processing or after processing in the formation of the concrete. Additional components can include mineral admixtures, liquid admixtures, and/or cementitious (binder) material. In general, mineral admixtures are solid powders that are added to supplement cement and are things like coal fly ash, ground slag (slag cement), silica fume, metakaolin, etc. In general, liquid admixtures can vary greatly in chemical compositions and desired effects and some common classes include water reducers, plasticizers, accelerators, air-entrainers, air-detrainers, permeability reducing admixtures, etc. In general, cementitious (binder) material is the combination of materials in a cementitious mixture that does not include fine or coarse aggregates, admixtures, reinforcement, or fibers. The cementitious materials can be assigned into two general groups: cementitious (or hydraulic) materials which are materials that react on their own with water, and supplementary cementitious materials which require an initial reaction (usually portland cement hydration) to happen before they can chemically react to form a hard substance (e.g., aggregates are considered separate from cementitious (binder) material). Cementitious/hydraulic materials would include portland cement, cement types other than portland cement, ground slag (slag cement), and coal fly ash, etc. Supplementary cementitious materials would include things like silica fume, ASTM C618 fly ash, metakaolin, etc.

For both the formation of cement and cementitious shielding composition, the fine aggregates can include natural or synthetic sand, crushed stone, or gravel, where the particles can pass through a ⅜-inch (9.5 mm) sieve. In regard to the formation of cement and concrete, the coarse aggregates can include synthetic or natural sand, crushed stone, or gravel, where the particles are greater than 0.19 inch (4.75 mm), or can be about 3/8 to 6 inches (9.5 to 150 mm) in the largest least dimension. The natural gravel and sand can be obtained from a pit, river, lake, or seabed. The crushed aggregate can be obtained by crushing quarry rock, boulders, cobbles, or large-size gravel. Recycled concrete and slags are also sources of aggregate.

The size distribution of the fine aggregates, and concrete particles, as well as other particles in the cementitious shielding system can have a distribution of sizes. The shapes of the fine aggregates, hydrogenous compounds, boron compounds, additives, and cement particles, as well as other particles in the cementitious shielding system can vary and be diverse (e.g., spherical, polygonal, random). The size distribution and shape variety can contribute to the characteristics of the cementitious shielding system.

The cementitious paste includes cement and water. The cementitious paste includes the cement, optionally cementitious materials, optionally geopolymers, optionally alkali activators, and optionally water. The cementitious mortar includes cementitious paste and fine aggregates (e.g., sand). Concrete includes cementitious mortar and coarse aggregate (e.g., rock).

As briefly described above, portland cement can be manufactured using a designed combination of calcium, silicon, aluminum, iron, and other ingredients that can be derived from limestone, shells, and chalk or marble combined with shale, clay, slate, blast furnace slag, silica sand, coal fly ash, and/or iron ore. These ingredients are brought to a high temperature (e.g., 2,700 to 3,000 degrees Fahrenheit or 1,500 to 1670 degrees Celsius), form small balls called clinkers that are then ground into the fine powder. In general, limestone and silica make up about 85 percent of the raw ingredients of cement, while other elements such as alumina and iron oxide are also included as well as the elemental boron or boron compounds. The high heat drives off water and carbon dioxide to form other materials that make up the cement matrix and in a portland cement these can include tricalcium silicate, dicalcium silicate, tricalcium aluminate and tetracalcium aluminoferrite. Other cement types such as calcium aluminate cements (CACs) and calcium sulfoaluminate cements (CSA cements) are comprised of different chemical compounds and manufacturing processes.

The cement matrix can be mixed with fine aggregates and hydrogenous compounds optionally along with admixtures. In general, the cementitious shielding system includes about 10 to 25 percent cementitious material, about 60 to 75 percent aggregate and about 5 to 15 percent water. The concrete can be formed through hydration, where the components harden and gain strength to form the cementitious shielding system.

The cementitious shielding composition can be used in multiple ways. For example, in a direct application method, the cementitious shielding composition is applied directly to the structural surface (e.g., concrete or steel), with or without the aid of supplementary bonding agents including, but not limited to latex polymers, film deposition by ureolytic or non-ureolytic bacterium, deposition or application of organic or inorganic polymers, hydraulic mortars, hydraulic pastes, etc. The surface of the existing structure is prepared in any manner required for suitable bond to be achieved including but not limited to: mechanical modification such as sand/media blasting, scarification, scoring, embedment of anchors into existing structure; chemical modification such as acid etching, application of a bonding agent; or no surface treatment. Once the surface is prepared, the cementitious shielding composition is thoroughly mixed on-site and is directly applied to the structure as a coating using a pressurized application gun similar to “shotcrete” or “gunite”. The thickness of the shielding component system is tailored specifically for the neutron fluence anticipated for the facility and therefore generally varies between about 0.25 inches (6 mm), to 8 inches (200 mm), but could be more or less as desired, for example about 6 mm to 150 mm, about 1 mm to 200 mm, about 1 mm to 150 mm, about 1 mm to 10 mm, about 3 mm to 10 mm, or about 3 mm to 9 mm.

In another example, the cementitious shielding composition can be used based on mechanical application. In this application method, the cementitious shielding composition is pre-formed into panels or other structure depending upon what is to be shielded that are mechanically fastened to the existing structure in a manner with sufficient restraint to prevent shifting of the panels under self-weight, but will not result in damage from differential thermal strain. This approach reduces downtime, installation costs, and variability as panels can be made off-site with strict uniform dimensional conformance, additionally, surface preparation beyond installation of anchors is not required. The thickness of the cementitious shielding composition can be tailored specifically for the neutron fluence anticipated for the facility and therefore generally varies between about 0.25 inches (6 mm), to 8 inches (200 mm), but could be more or less as desired, for example about 6 mm to 150 mm, about 1 mm to 200 mm, about 1 mm to 150 mm, about 1 mm to 10 mm, about 3 mm to 10 mm, or about 3 mm to 9 mm.

Now having described the present disclosure in some detail, additional details are provided below.

In an aspect, the present disclosure provides a cementitious shielding composition comprising: a fine aggregate, hydrogenous compounds, hydraulic compounds, optionally an additive, and optionally boron particles;
wherein the boron particles are present in the fine aggregate, the hydrogenous compounds, the hydraulic compounds, or a combination thereof, or
wherein the boron particles are present separately from the fine aggregate, the hydrogenous compounds, the hydraulic compounds, or present in the fine aggregate, the hydrogenous compounds, the hydraulic compounds, or a combination thereof;
and wherein the boron particles are present separately from the fine aggregate, the hydrogenous compounds, the hydraulic compounds;
wherein the boron particles comprise a boron compound, elemental boron, or a combination thereof, wherein the boron particles have a largest least dimension of about 100 microns or less, wherein the boron particles are dispersed homogeneously in the cementitious shielding composition.

In the preceding aspect, the hydrogenous compounds comprise the boron particles.

In the preceding aspects, the hydraulic compounds comprise the boron particles.

In the preceding aspects, the fine aggregate includes fine aggregate particles, wherein the boron particles comprise a coating for each of the fine aggregate particles.

In the preceding aspects, the cementitious shielding composition has the characteristic that when applied to a concrete structure, the cementitious shielding composition reduces neutron flux from reaching beyond the coating leading to radiation-induced volumetric expansion of the one or more types of the aggregate particles in the concrete relative to concrete that does not include the cementitious shielding composition.

In the preceding aspects, the boron compound is selected from the group consisting of: boron minerals, organoboron compounds, borates and their hydrated forms, borate esters and their hydrated forms, borate salts and their hydrated forms, ionic borohydrides, and a combination thereof.

In the preceding aspects, the fine aggregates are about 10 to 80 weight percent of the cementitious shielding composition, wherein the hydrogenous compounds are about 1 to 65 weight percent of the cementitious shielding composition, optionally an additive is 0 to 10 weight percent, and the hydraulic binder is about 10 to 40 weight percent of the cementitious shielding composition.

In the preceding aspects, the cementitious shielding composition has an elemental boron composition of about 1 to 10 weight percent of the cementitious shielding composition.

In the preceding aspects, a ¹⁰B abundance percentage in the boron compound or elemental boron is greater than the natural abundance of about 20 percent.

In the preceding aspects, the hydrogenous compounds are in the form of particles that have a largest least dimension of about 100 microns or less, wherein the hydrogenous compounds are dispersed homogeneously in the cementitious shielding composition.

In the preceding aspects, the hydrogenous compounds include hydrated cement phases, cementitious pore fluid, hydrated minerals/salts, inorganic polymers, organic polymers, or combinations thereof.

In the preceding aspects, the hydraulic binder is in the form of particles that have a largest least dimension of about 100 microns or less, wherein the hydrogenous compounds are dispersed homogeneously in the cementitious shielding composition.

In the preceding aspects, the hydraulic binder includes portland cement, blended cement, slag cement, fly ash, silica fume, metakaolin, geopolymer, alkali-activated slag cement, calcium sulfoaluminate cement, calcium aluminate cement, belite cement, lime cement, supplementary cementitious materials not meeting ASTM C618, or combinations thereof.

In the preceding aspects, the additive is present, wherein the additive includes liquid or solid plasticizing admixtures, water reducing admixtures, air-entraining admixtures, viscosity modifying admixtures, set retarding admixtures, set accelerating admixtures, internal curing admixtures, alkali activators, biofilm bacterium, activated carbon, carbon powder, synthetic fibers, glass fibers, carbon fibers, basalt fibers, steel fibers, aluminum fibers, cellulose fibers, plant-based fibers, or combinations thereof.

In the preceding aspects, the cementitious shielding composition further comprises high density polyethylene.

In the preceding aspects, a portion of the fine aggregate is high density polyethylene, optionally wherein the portion is about 1 to 25 weight percent of the fine aggregate.

In the preceding aspects, the boron particles are present in the fine aggregate, the hydrogenous compounds, the hydraulic compounds, or a combination thereof

In the preceding aspects, the boron particles are present separately from the fine aggregate, the hydrogenous compounds, the hydraulic compounds, or combinations thereof.

In the preceding aspects, the boron particles are present in the fine aggregate, the hydrogenous compounds, the hydraulic compounds, or a combination thereof and present separately from the fine aggregate, the hydrogenous compounds, the hydraulic compounds.

In an aspect, a cementitious shielding composition comprises: a fine aggregate, hydrogenous compounds, hydraulic compounds, optionally an additive, and optionally boron particles;
wherein the fine aggregates include fine aggregate particles, wherein the hydrogenous compounds are in the form of hydrogenous particles, wherein the hydraulic compounds are in the form of hydraulic particles;
wherein one or more of the fine aggregate particles, hydrogenous particles, hydraulic particles, or a combination thereof have a boron coating, wherein the boron coating comprises boron particles, wherein the boron particles comprise a boron compound, elemental boron, or a combination thereof, wherein the boron particles have a largest least dimension of about 100 microns or less, wherein the boron particles is dispersed homogeneously in the cementitious shielding composition.

In the preceding aspects, the hydrogenous compounds comprise the boron particles.

In the preceding aspects, the hydraulic compounds comprise the boron particles.

In the preceding aspects, the cementitious shielding composition has the characteristic that when applied to a concrete structure, the cementitious shielding composition reduces neutron flux from reaching beyond the coating leading to radiation-induced volumetric expansion of the one or more types of the aggregate particles in the concrete relative to concrete that does not include the cementitious shielding composition.

In the preceding aspects, the boron compound is selected from the group consisting of: boron minerals, organoboron compounds, borates and their hydrated forms, borate esters and their hydrated forms, borate salts and their hydrated forms, ionic borohydrides, and a combination thereof.

In the preceding aspects, the fine aggregates are about 10 to 80 weight percent of the cementitious shielding composition, wherein the hydrogenous compounds are about 1 to 65 weight percent of the cementitious shielding composition, optionally an additive is 0 to 10 weight percent, and the hydraulic binder is about 10 to 40 weight percent of the cementitious shielding composition.

In the preceding aspects, the cementitious shielding composition has an elemental boron composition of about 1 to 10 weight percent of the cementitious shielding composition.

In the preceding aspects, a ¹⁰B abundance percentage in the boron compound or elemental boron is greater than the natural abundance of about 20 percent.

In the preceding aspects, the hydrogenous compounds are in the form of particles that have a largest least dimension of about 100 microns or less, wherein the hydrogenous compounds are dispersed homogeneously in the cementitious shielding composition.

In the preceding aspects, the hydrogenous compounds include hydrated cement phases, cementitious pore fluid, hydrated minerals/salts, inorganic polymers, organic polymers, or combinations thereof.

In the preceding aspects, the hydraulic binder is in the form of particles that have a largest least dimension of about 100 microns or less, wherein the hydrogenous compounds are dispersed homogeneously in the cementitious shielding composition.

In the preceding aspects, the hydraulic binder includes portland cement, blended cement, slag cement, fly ash, silica fume, metakaolin, geopolymer, alkali-activated slag cement, calcium sulfoaluminate cement, calcium aluminate cement, belite cement, lime cement, supplementary cementitious materials not meeting ASTM C618, or combinations thereof.

In the preceding aspects, the additive is present, wherein the additive includes liquid or solid plasticizing admixtures, water reducing admixtures, air-entraining admixtures, viscosity modifying admixtures, set retarding admixtures, set accelerating admixtures, internal curing admixtures, alkali activators, biofilm bacterium, activated carbon, carbon powder, synthetic fibers, glass fibers, carbon fibers, basalt fibers, steel fibers, aluminum fibers, cellulose fibers, plant-based fibers, or combinations thereof.

In the preceding aspects, the cementitious shielding composition further comprising high density polyethylene.

In the preceding aspects, a portion of the fine aggregate is high density polyethylene, optionally wherein the portion is about 1 to 25 weight percent of the fine aggregate.

In an aspect, a structure comprising a coating made from the cementitious shielding composition described herein.

In the preceding aspects, the coating has a thickness of about 1 mm to 150 mm.

In the preceding aspects, the coating has a thickness of about ¼ inches (6 mm), to 6 inches (150 mm).

In the preceding aspects, the structure is a panel having the coating made from the cementitious shielding composition deposed thereon, wherein the panel is configured to be secured to a structure in need of shielding from fast, epi-thermal, thermal neutrons, or a combination thereof.

In the preceding aspects, the structure is structural component that experiences neutron radiation in a nuclear power plant or neutron therapy facility or proton therapy facility.

In the preceding aspects, the structure is a structural component part of a nuclear reactor building, a storage building or structure, a containment building or structure, a shielding building or structure, or piping.

### EXAMPLE 1

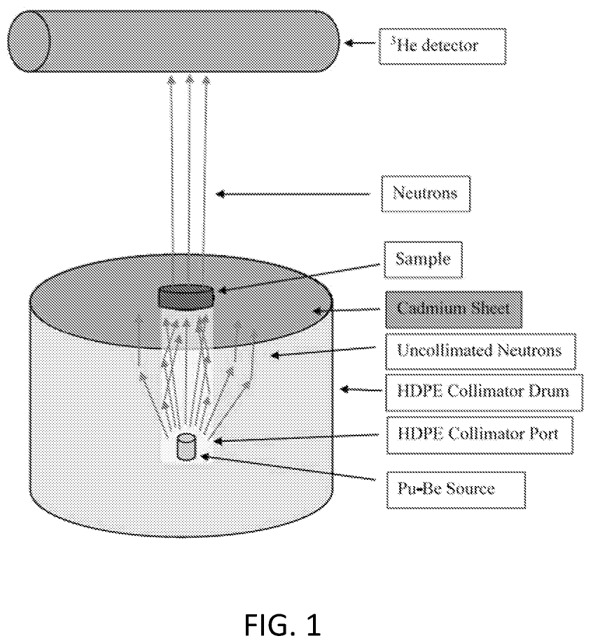

To evaluate shielding potential of the proposed technology, a plutonium beryllium neutron source was used to generate neutrons. As shown in FIG. 1, a Pu-Be source was placed into a high-density polyethylene transport drum with a collimation port. A cadmium sheet with a hole the diameter of the collimation port was placed over the transport drum to shield against neutrons interacting with the detector that bypass the specimens. Specimens of differing compositions were placed above the collimation port to expose the specimens directly to the Pu-Be source and a ³He detector was placed behind the specimens to measure neutrons passing through the specimens as shown below.

Prior to placing specimens in the path of the neutrons, the detector collected baseline data (represented as 100% neutrons in the following graphs). The detection time was adjusted such that counting statistics represented 99% confidence. Three compositions were evaluated: typical nuclear shielding concrete containing heavyweight aggregate utilizing a mixture design and aggregate source from a proton therapy facility, a portland cement mortar composition with 4 kg ¹⁰B/m³ using boron carbide as a sand replacement, and a portland cement mortar composition with 20 kg ¹⁰B/m³ using boron carbide as a sand replacement along with 20% HDPE as a sand replacement.

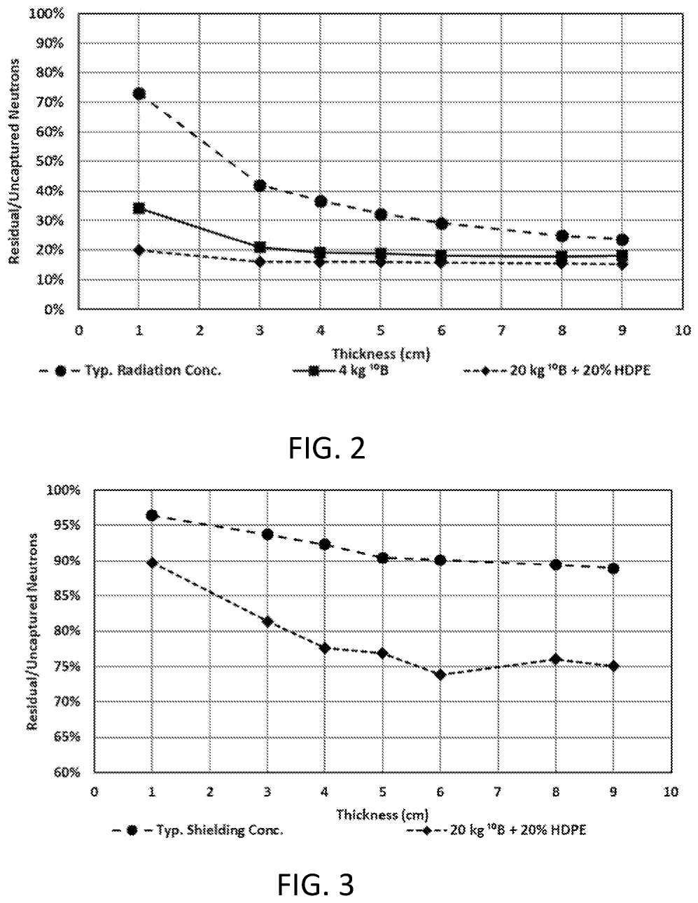

In the original configuration, the plutonium beryllium source produced neutrons from approximately 0-12 MeV with an average neutron energy of approximately 5.5 MeV. Each mixture was used to create specimens having thicknesses of 1, 3, and 5 cm. Utilizing stacked specimens, shielding at thicknesses of 1, 3, 4, 5, 6, 8, and 9 cm was performed, which is illustrated in the graph in FIG. 2. The results of the shielding efficiency versus shielding thickness is presented below for the mixed energy spectrum.

Following this experiment, a cadmium sheet was placed over the collimation port to shield against thermal neutrons prior to exposing the specimens (meaning the specimens were being exposed to a nearly pure fast-neutron source), which is illustrated in FIG. 3. In previous experiments, the presence of boron alone does not appreciably affect the neutron capture of fast neutrons, so only the HDPE amended mixture was tested. In this instance, the HDPE should moderate (slow) the fast neutrons into the thermal and epithermal range allowing the boron present to transmute and capture the slower neutrons, increasing shielding efficiency. The results of this test are presented below.

In both instances, the shielding mixtures showed a reduction in shielding thickness of approximately 90% with approximately equivalent or better shielding potential.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

1. A cementitious shielding composition comprising: a fine aggregate, hydrogenous compounds, hydraulic compounds, optionally an additive, and optionally boron particles;
wherein the boron particles are present in the fine aggregate, the hydrogenous compounds, the hydraulic compounds, or a combination thereof or are present separately from the fine aggregate, the hydrogenous compounds, the hydraulic compounds, or present in the fine aggregate, the hydrogenous compounds, the hydraulic compounds, or a combination thereof and present separately from the fine aggregate, the hydrogenous compounds, the hydraulic com pounds;
wherein the boron particles comprise a boron compound, elemental boron, or a combination thereof, wherein the boron particles have a largest least dimension of about 100 microns or less, wherein the boron particles are dispersed homogeneously in the cementitious shielding com position.

2. The cementitious shielding composition of claim 1, wherein the hydrogenous compounds comprises the boron particles.

3. The cementitious shielding composition of claim 1, wherein the hydraulic compounds comprises the boron particles.

4. The cementitious shielding composition of claim 1, wherein the fine aggregate includes fine aggregate particles, wherein the boron particles comprise a coating for each of the fine aggregate particles.

5. (canceled)

6. The cementitious shielding composition of claim 1, wherein the boron compound is selected from the group consisting of: boron minerals, organoboron compounds, borates and their hydrated forms, borate esters and their hydrated forms, borate salts and their hydrated forms, ionic borohydrides, and a combination thereof.

7. The cementitious shielding composition of claim 1, wherein the fine aggregates are about 10 to 80 weight percent of the cementitious shielding composition, wherein the hydrogenous compounds are about 1 to 65 weight percent of the cementitious shielding composition, optionally an additive is 0 to 10 weight percent, and the hydraulic binder is about 10 to 40 weight percent of the cementitious shielding composition.

8. The cementitious shielding composition of claim 1, wherein the cementitious shielding composition has an elemental boron composition of about 1 to 10 weight percent of the cementitious shielding composition.

9. The cementitious shielding composition of claim 1, wherein a 10 B abundance percentage in the boron compound or elemental boron is greater than the natural abundance of about 20 percent.

10-16. (canceled)

17. The cementitious shielding composition of claim 1, wherein the boron particles are present in the fine aggregate, the hydrogenous compounds, the hydraulic compounds, or a combination thereof

18. The cementitious shielding composition of claim 1, wherein the boron particles are present separately from the fine aggregate, the hydrogenous compounds, the hydraulic compounds, or combinations thereof.

19. The cementitious shielding composition of claim 1, wherein the boron particles are present in the fine aggregate, the hydrogenous compounds, the hydraulic compounds, or a combination thereof and present separately from the fine aggregate, the hydrogenous compounds, the hydraulic compounds.

20. A cementitious shielding composition comprising: a fine aggregate, hydrogenous compounds, hydraulic compounds, optionally an additive, and optionally boron particles;
wherein the fine aggregates include fine aggregate particles, wherein the hydrogenous compounds are in the form of hydrogenous particles, wherein the hydraulic compounds are in the form of hydraulic particles;
wherein one or more of the fine aggregate particles, hydrogenous particles, hydraulic particles, or a combination thereof have a boron coating, wherein the boron coating comprises boron particles, wherein the boron particles comprise a boron compound, elemental boron, or a combination thereof, wherein the boron particles have a largest least dimension of about 100 microns or less, wherein the boron particles is dispersed homogeneously in the cementitious shielding com position.

21. The cementitious shielding composition of claim 20, wherein the hydrogenous compounds comprises the boron particles.

22. The cementitious shielding composition of claim 20, wherein the hydraulic compounds comprises the boron particles.

23-29. (canceled)

30. The cementitious shielding composition of claim 20, wherein the hydraulic binder is in the form of particles that have a largest least dimension of about 100 microns or less, wherein the hydrogenous compounds are dispersed homogeneously in the cementitious shielding composition.

31. The cementitious shielding composition of claim 30, wherein the hydraulic binder includes portland cement, blended cement, slag cement, fly ash, silica fume, metakaolin, geopolymer, alkali-activated slag cement, calcium sulfoaluminate cement, calcium alum inate cement, belite cement, lime cement, supplementary cementitious materials not meeting ASTM C618, or combinations thereof.

32-34. (Canceled)

35. A structure comprising a coating made from the cementitious shielding composition described in any one of claim 1 or 34.

36. The structure of claim 35, wherein the coating has a thickness of about 1 mm to 150 mm.

37. (canceled)

38. The structure of claim 35, wherein the structure is a panel having the coating made from the cementitious shielding composition deposed thereon, wherein the panel is configured to be secured to a structure in need of shielding from fast, epi-thermal, thermal neutrons, or a combination thereof.

39. (canceled)

40. The structure of claim 35, wherein the structure is a structural component part of a nuclear reactor building, a storage building or structure, a containment building or structure, a shielding building or structure, or piping.
